(19) United States
(12) Patent Application Publication
(10) Pub. No.: US 2025/0390606 A1
(43) Pub. Date: Dec. 25, 2025

(54) Privacy Data Augmentation

(71) Applicant: Verizon Patent and Licensing Inc., Basking Ridge, NJ (US)

(72) Inventors: Tushar Singh, Karnataka (IN); Saurabh Tahiliani, Uttar Pradesh (IN); Durgesh Kumar, Karnataka (IN); Subham Biswas, Maharashtra (IN)

(21) Appl. No.: 18/751,457

(22) Filed: Jun. 24, 2024

(51) Int. Cl. G06F 21/62; G06F 40/284

(52) U.S. Cl. CPC G06F 21/6263; G06F 40/284

(57) ABSTRACT

One or more computing devices, systems, and/or methods for privacy data augmentation are provided. An augmentation pipeline is selected to process data based upon a data type of the data. The augmentation pipeline processes the data to generate information that is input into a machine learning model. The machine learning model processes the information and privacy laws to determine a subset of the data to mask. In this way, the subset of the data is masked to create augmented data that complies with the privacy laws.

### BACKGROUND

Many organizations have a global workforce that is spread across multiple countries. Each country may have its own data privacy regulations. For example, a data privacy regulation may specify that social security numbers are to be masked (e.g., redacted such as blacked out) for certain types of data and/or use cases. The data privacy regulation may specify that faces are to be masked (e.g., blurred or blacked out) in images for certain image use cases. Thus, the organizations must maintain or share data in a manner that complies with the various data privacy regulations in the different countries where the data resides or is to be accessed.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for privacy data

augmentation, in accordance with an embodiment of the present technology;

FIG. 2 is a flow chart illustrating an example method for privacy data augmentation for text-based data, in accordance with an embodiment of the present technology;

FIGS. 3A-3C illustrate an example of a system for privacy data augmentation for text-based data, in accordance with an embodiment of the present technology;

FIG. 4 is a flow chart illustrating an example method for privacy data augmentation for image-based data, in accordance with an embodiment of the present technology;

FIGS. 5A-5D illustrate an example of a system for privacy data augmentation for image-based data, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

Systems and methods are provided for privacy data augmentation. Different regions such as different countries may have their own data privacy regulations that restrict how data is maintained or is transmitted into or out of the regions. Compliance becomes technically challenging for organizations that have a global workforce spread across multiple regions or countries. For example, if a user in India is to access data maintained in Canada, then data privacy regulations of both Canada and India may apply to the user accessing the data. The data privacy regulations of one of the countries may specify that telephone numbers must be masked (e.g., redacted) for compliance, while the other country may specify that both telephone numbers and last names must be masked for compliance. Thus, data clearance is a major technical hurdle for compliance where decentralized and efficient resource utilization cannot be achieved, and conventional data masking/redaction techniques have numerous issues. For example, conventional data masking/redaction techniques do not consider what is being conveyed by the data, and may merely mask all data or more data than necessary (e.g., blurring entire bodies when only faces need to be blurred in an image), thus leaving the remaining data unusable (e.g., the image could have been used for security monitoring purposes if the bodies could have been visible).

The disclosed techniques overcome these technical challenges and deficiencies of conventional masking/redaction techniques by implementing a dynamic artificial intelligence based privacy data augmentation technique that is based upon geo-localized regulations. The disclosed techniques leverage artificial intelligence to dynamically mask data based upon source and destination privacy regulations of where data resides and will be transmitted. Accordingly, the data can be dynamically evaluated and masked using various types of machine learning models and artificial intelligence. The data is masked utilizing an augmentation pipeline that is selected based upon a data type of the data to mask. The augmentation pipeline identifies entities within the data (e.g., a bat and baseball player depicted by an image; a name, phone number, location, etc. mentioned within text; etc.). A contextual prompt is created based upon the entities, and is input into a model that identifies which entities to mask. In this way, the entities within the data are masked to create augmented data that is transmitted to a computing device at a destination region.

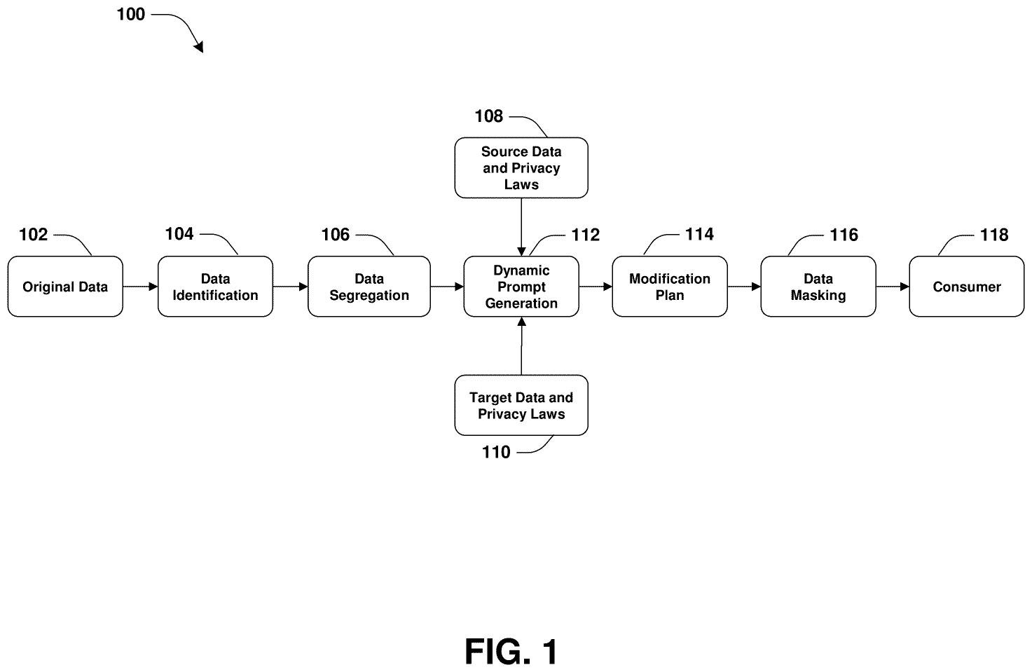

FIG. 1 illustrates an example of a system 100 for privacy data augmentation. Original data 102 may comprise text-based data, image-based data, or a combination thereof. The original data 102 may reside within a source region (e.g., the original data 102 may comprise text or imagery that is stored within a data center in a first country). A consumer 118 such as a device of a user located within a destination region (e.g., a second country) may request access to the original data 102. Accordingly, the system 100 may implement privacy data augmentation for the original data 102 in order to comply with source data and privacy laws 108 (source regulations) and/or target data and privacy laws 110 (destination regulations).

The system 100 performs data identification 104 to identify the different types of data within the original data 102 such as text or imagery. The data identification 104 may identify text/numeric content that can be processed using a text augmentation pipeline. The data identification 104 may identify image data that can be processed using an image augmentation pipeline. The data identification 104 may perform optical character recognition (OCR) the image data to identify text/numeric content that can be processed using the text augmentation pipeline (e.g., an image of a driver's license).

The system 100 performs data segregation 106 upon the original data 102 using one or more of the augmentation pipelines. The text augmentation pipeline may perform tokenization, part of speech tagging, entity detection, and entity tagging upon text-based data of the original data 102. In this way, a token is identified as being an entity or not (e.g., a name, a phone number, a location, a date, a person, an object, etc.). The image augmentation pipeline may utilize various layers such as conversion layers, max pooling layers, attention layers, dense layers, and/or other machine learning model layers/functionality in order to determine bounding box coordinates of bounding boxes to create within image data to encompass objects (e.g., a bat, a ball, a baseball player, etc.) depicted by the image data.

The output of the data segregation 106, the source data and privacy laws 108, and the target data and privacy laws 110 are input into dynamic prompt generation 112. The text augmentation pipeline may utilize the entities identified in the original data 102, the source data and privacy laws 108, and the target data and privacy laws 110 to generate a contextual prompt that is input into a model such as a generative large language model to create key variables used for data masking. The image augmentation pipeline may generate a contextual prompt using the source data and privacy laws 108 and the target data and privacy laws 110. The contextual prompt is input into a model such as the generative large language model to create key classes used for data masking. In this way, a modification plan 114 for masking the original data 102 is generated. The modification plan 114 may identify which entities/classes to mask such as faces, social security numbers, dates of birth, etc. Accordingly, data masking 116 is performed to utilize the modification plan 114 to mask the original data 102 to create augmented data. The augmented data will satisfy the source data and privacy laws 108 and the target data and privacy laws 110. The augmented data is then provided to the consumer 118 such as for display through the device located within the destination region.

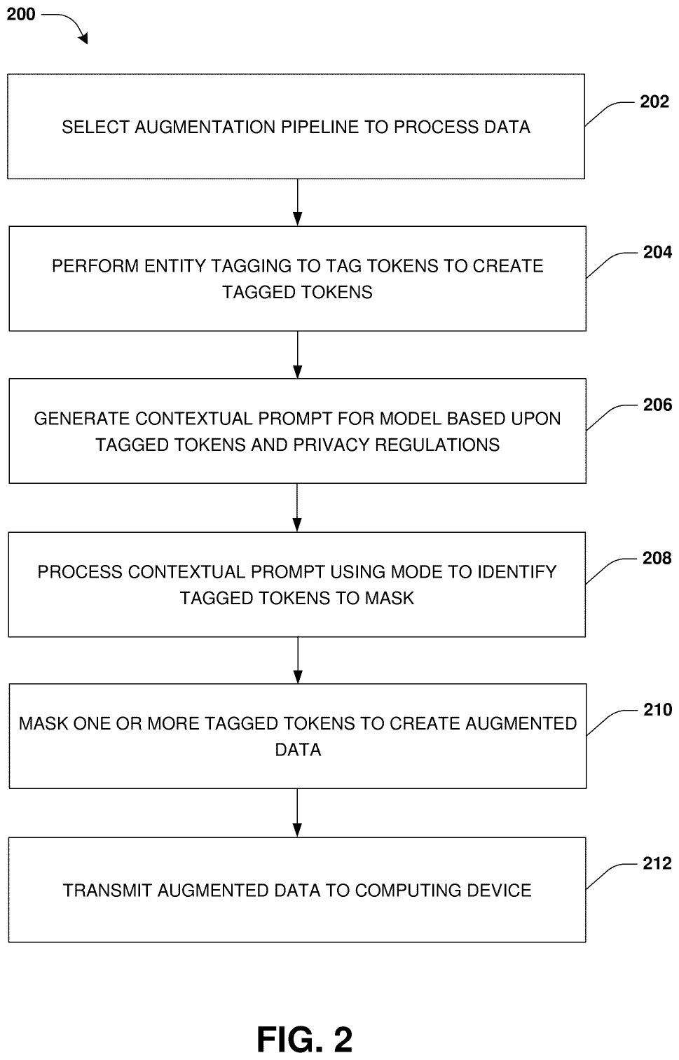

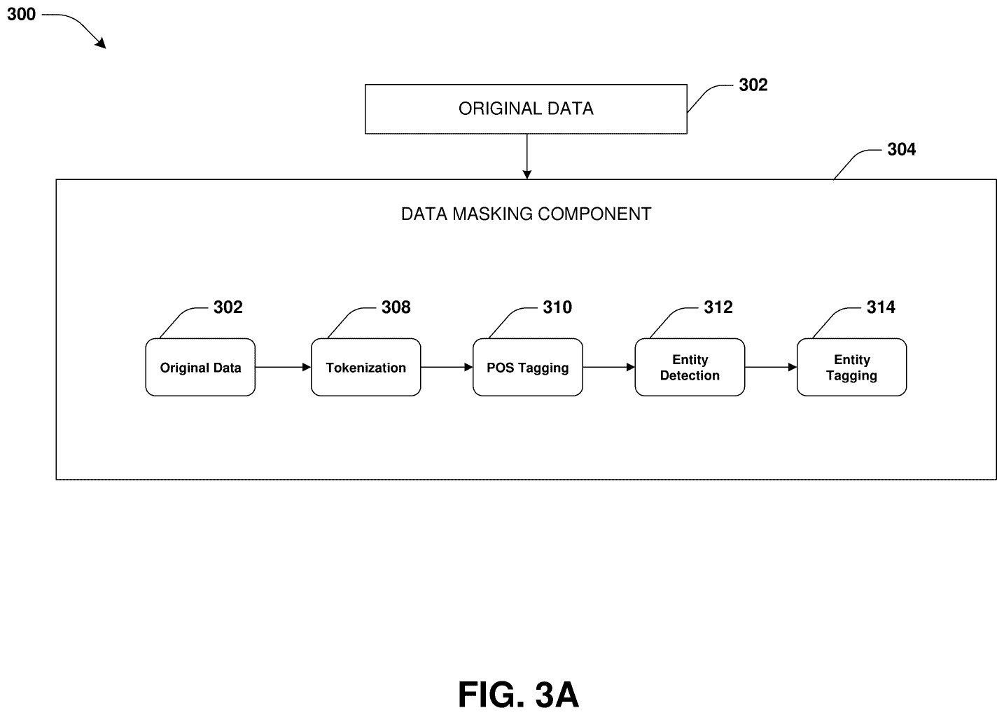

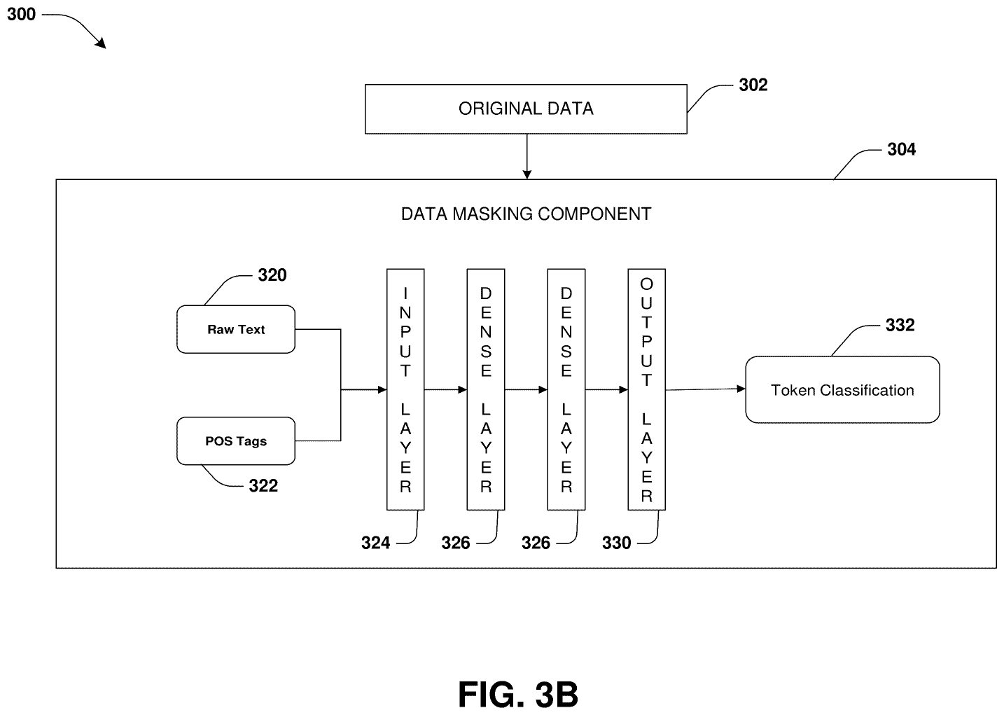

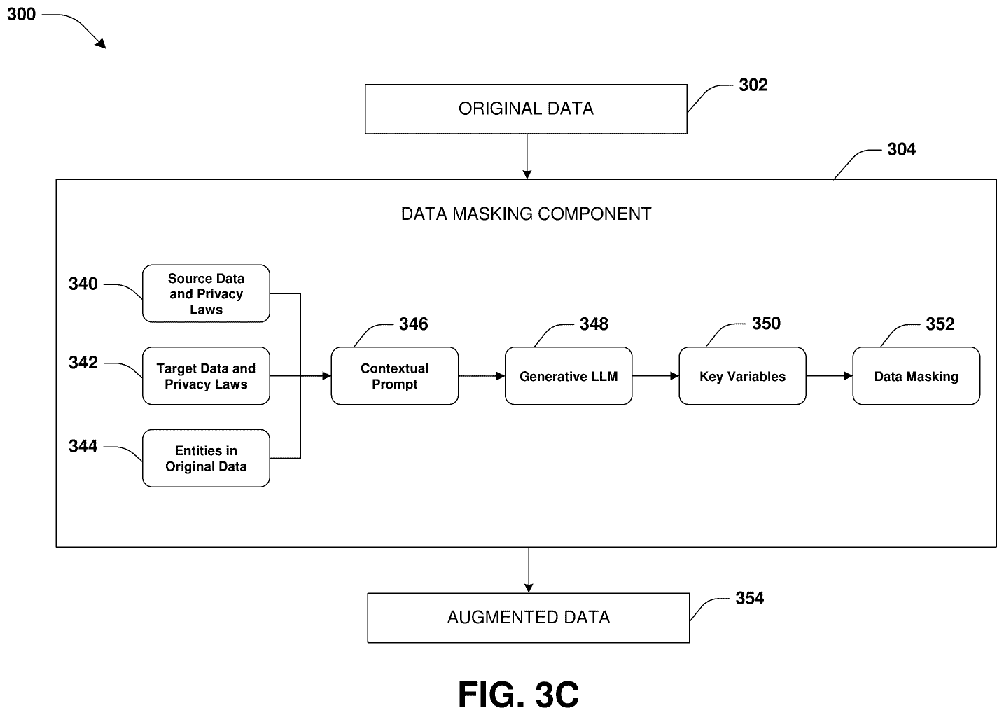

FIG. 2 is a flow chart illustrating an example method 200 for privacy data augmentation for text-based data, which is described in conjunction with system 300 of FIGS. 3A-3C. The original data 302 may be stored within a storage device located within a source region (e.g., a presentation document stored within a data center located within a first country), as illustrated by FIG. 3A. A computing device located at a destination region may request access to the original data 302 (e.g., a user may attempt to access the presentation document from a computer located at a second country). The source region may have source privacy regulations specifying certain restrictions on how data is maintained and/or transmitted into the source region or transmitted out of the source region. In response to determining that the original data 302 is to be accessed by the computing device located at the destination region, a data masking component 304 is executed for processing the original data 302.

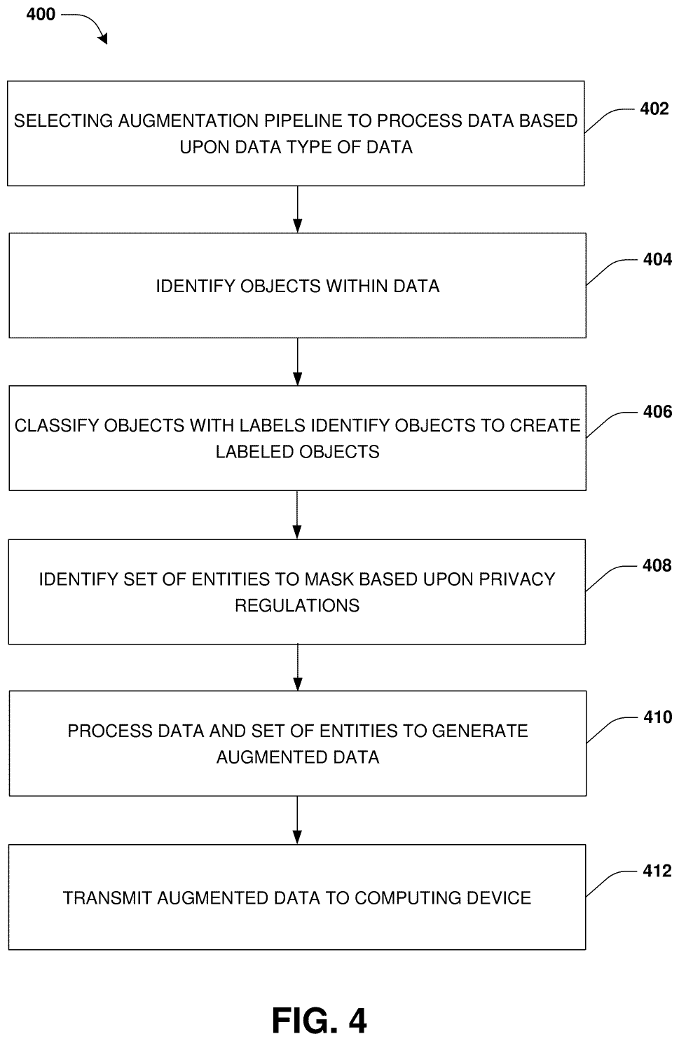

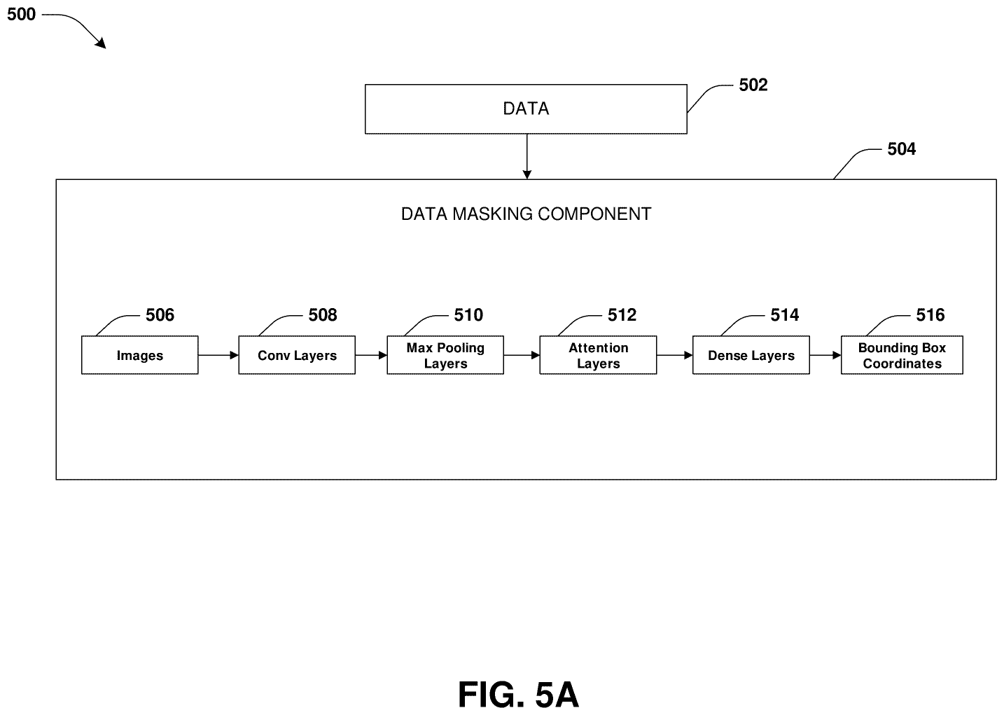

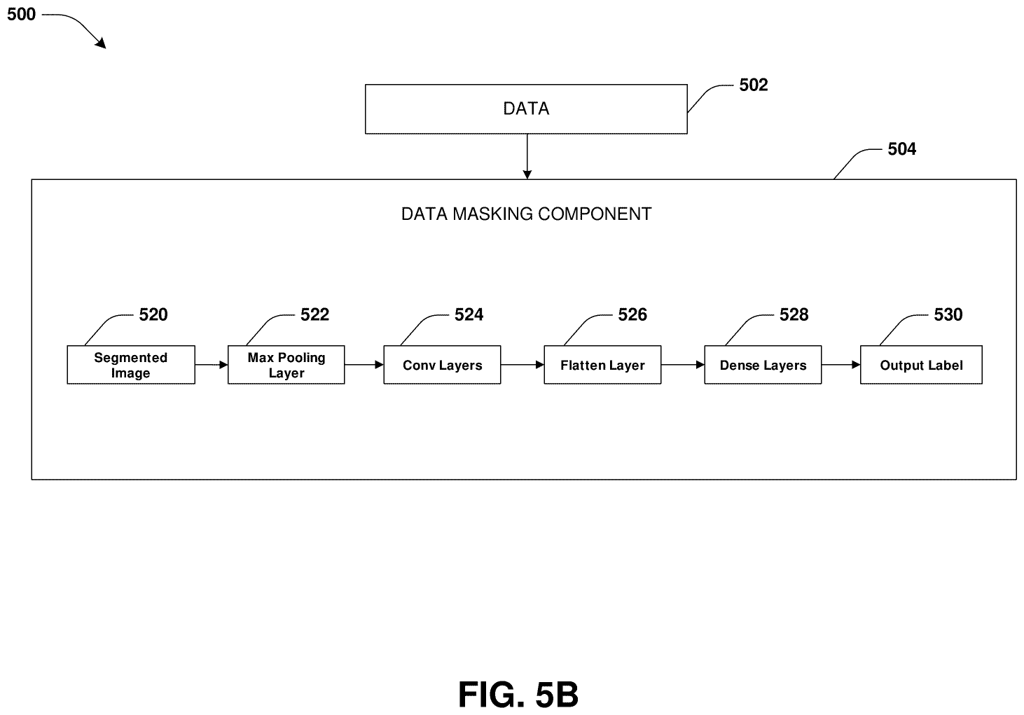

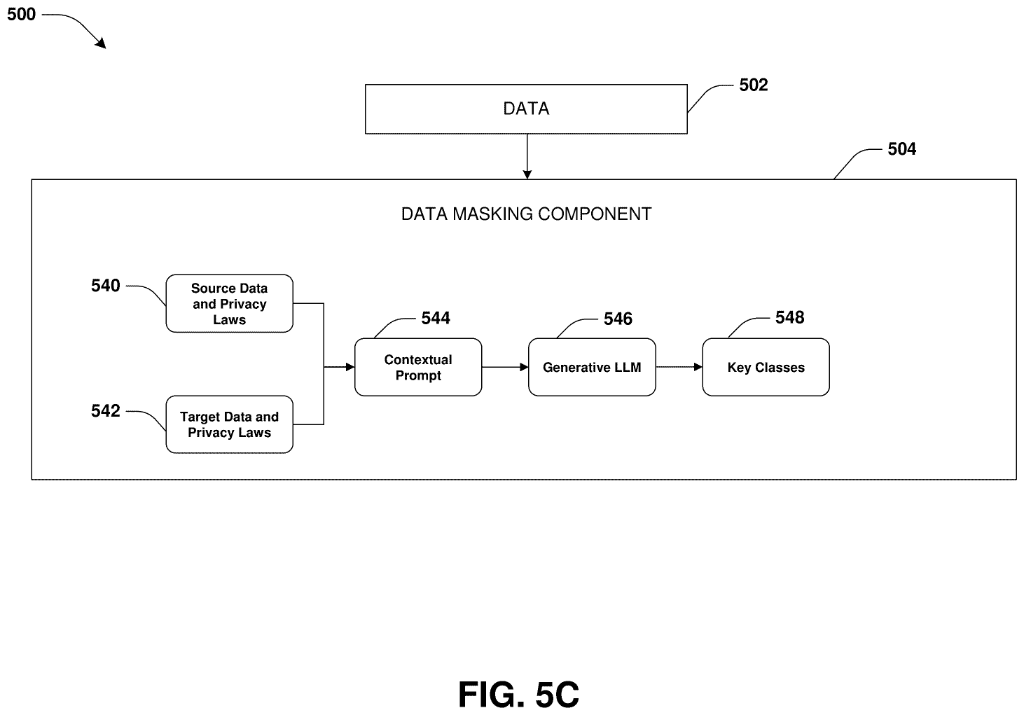

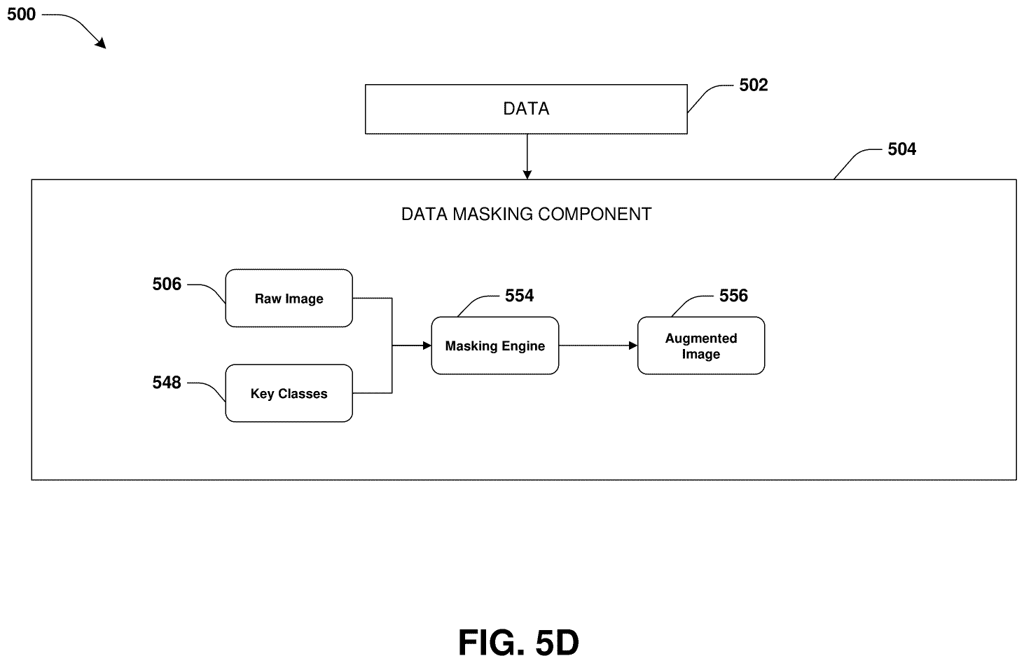

During operation 202 of method 200, the data masking component 304 selects an augmentation pipeline for processing the original data 302 based upon a data type of the data. For example, the data masking component 304 may determine that the original data 302 is text-based data, and thus a text augmentation pipeline is selected, as illustrated by FIGS. 3A-3C. It may be appreciated that selection of an image augmentation pipeline to process image data will be subsequently described in relation to FIGS. 4 and 5A-5D. If the original data 302 includes a combination of text and imagery, then both the text augmentation pipeline and the image augmentation may be selected and used to process and mask corresponding data.

During operation 204 of method 200, the text augmentation pipeline performs entity tagging 314 to tag tokens within the original data 302 as tagged tokens that are tagged as either being entity tokens (e.g., a string of numbers representing a phone number) or non-entity tokens (e.g., a string of numbers or letters that do not represent a location, a person, a thing or object, or other entity). In particular, the data masking component 304 executes the text augmentation pipeline to perform tokenization 308 upon the original data 302 in order to identify tokens such as words or phrases. Part of speech tagging 310 is performed to tag the tokens with part of speech tags to create tagged tokens (e.g., a string of characters may be tagged as a noun, a verb, an adjective, a pronoun, etc.). The raw text of the original data 302 and the tagged tokens are processed to perform entity detection 312 to identify entities (e.g., a person, place, or thing) that are tagged by the entity tagging 314.

In some embodiments of entity detection and tagging, a model may be used to output token classifications 332, as illustrated by FIG. 3B. The raw text 320 of the original data 302 and the part of speech tags 322 are input into a model that includes an input layer 324, one or more dense layers 326, and an output layer 330. In some embodiments, the model may be a sequential multi-layer perceptron model and the dense layers 326 may be a fully connected dense layer type. The model may utilize activation functions such as a leaky rectifier linear unit, and a loss is determined as categorical cross-entropy. In this way, the various layers of the model process the raw text 320 of the original data 302 and the part of speech tags 322 to create the token classifications 332 for classifying and tagging the tokens.

During operation 206 of method 200, the data masking component 304 generates a contextual prompt 346, as illustrated by FIG. 3C. The contextual prompt 346 is created based upon the tagged tokens corresponding to entities 344 identified and tagged in the original data 302, source data and privacy laws 340 (privacy regulations for the source region), and/or destination data and privacy laws 342 (privacy regulations for the destination region). During operation 208 of method 200, the contextual prompt 346 is input into a model such as a generative large language model 348 or any other type of machine learning model to create key variables 350 corresponding to tagged tokens to mask (e.g., a last name, a data of birth, a mobile phone number, etc.).

In some embodiments, the model is pre-trained using masking logic. The masking logic may specify logic such as adjective -> noun (JJ -> NN), verb -> noun (VB -> NN), noun -> and -> noun (NN ->CC -> NN), verb -> in -> noun (VB -> IN -> NN), verb, noun, adjective, etc. used by an encoder. The objective of the pre-training is set to capture relationships between different words and phrases, and the encoder is taught the way of representing words while keeping connections between the words intact. In some embodiments, the encoder is trained on a phrase “loving Company located in New York City” where Company and New York City is to be masked, resulting in “loving <mask> located in <mask>.” In this way, the model may be pre-trained using the encoder.

During operation 210 of method 200, the one or more tagged tokens, corresponding to the key variables 350, are masked 352 to create augmented data 354. In some embodiments, the augmented data 354 comprises a subset of the text of the original data 302 that is masked 352 (e.g., redacted blacked out, blurred, etc.), whereas other text of the original data 302 is not masked within the augmented data 354. In some embodiments, the source data and privacy laws 340 (privacy regulations for the source region) and/or destination data and privacy laws 342 (privacy regulations for the destination region) are evaluated to identify a set of entities to mask. In some embodiments, if either of the privacy regulations indicate that an entity is to be masked, then the entity is included within the set of entities. If a tagged token corresponds to an entity within the set of entities, then the tagged token is masked 352. During operation 212 of method 200, the augmented data 354 is provided to the computing device within the destination region in compliance with the privacy regulations.

The data masking component 304 may be used to create augmented data 354 for various technical use cases. In some embodiments, the augmented data 354 may be used for providing and receiving messages through a chatbot where certain entities are masked. In some embodiments, the augmented data 354 is processed using an intent identification model to identify an intent of a user or subject matter described by text of the original data 302. In some embodiments, the augmented data 354 may be input into a churn propensity model such as to process customer service scripts to identify customers that deactivate their accounts with a service provider. In some embodiments, the augmented data 354 may be input into a market analysis function for performing market analysis using augmented customer data. In some embodiments, the augmented data 354 may be used for variable regression. In some embodiments, the augmented data 354 may be input into functionality to generate and execute instructions for configuring or controlling network equipment of a communication network.

FIG. 4 is a flow chart illustrating an example method 400 for privacy data augmentation for image-based data, which is described in conjunction with system 500 of FIGS. 5A-5D. Data 502 may be stored within a storage device located within a source region (e.g., a marketing document stored within a data center located within a first country), as illustrated by FIG. 5A. A computing device located at a destination region may request access to the data 502 (e.g., a user may attempt to access the marketing document from a computer located at a second country). The source region may have source privacy regulations specifying certain restrictions on how data is maintained and/or transmitted into the source region or transmitted out of the source region. In response to determining that the data 502 is to be accessed, a data masking component 504 is executed for processing the original data 302.

During operation 402 of method 400, the data masking component 504 selects an augmentation pipeline for processing the data 502 based upon a data type of the data. For example, the data masking component 504 selects an image augmentation pipeline to process image data 506 (visual data) identified within the data 502. During operation 404 of method 400, the image augmentation pipeline may be executed to identify objects within the image data 506. In some embodiments, a model such as a neural network model may be used to segment boundaries within the image data 506 for identifying the objects. In some embodiments, the neural network model is a custom attention based neural network model that utilizes pre-annotated image datasets for training. The custom attention based neural network model is trained to identify and learn objects of interest in the existing pre-annotated image datasets (e.g., a ball, a bat, a pitcher, etc.). The custom attention based neural network model identifies and learns segmentation boundaries within images, and predicts bounding box coordinates. In this way, the model, such as the custom attention based neural network model, is trained to identify objects within image data.

In some embodiments, a gradient shift associated with a potential object in focus is detected and used to create a bounding box around the object based upon the gradient shift. In some embodiments, a model is used to generate bounding box coordinates 516 for bounding boxes created around the objects. The model may utilize various layers such as conversion layers 508, max pooling layers 510, attention layers 512, dense layers 514, etc. in order to determine bounding box coordinates 516 of bounding boxes to create within the image data 506 to encompass objects, as illustrated by FIG. 5A.

During operation 406 of method 400, the objects are classified with labels 530 identifying the objects to create labeled objects (e.g., car object may be labeled with a car label, a tree object may be labeled with a tree label, etc.). In some embodiments, the labels 530 may be assigned to bounding boxes described by the bounding box coordinates 516. A model may be used to create the labels 530. The model may utilize various layers such as max pooling layers 522, conversion layers 524, flattening layers 526, dense layers 528, and/or other layers to process a segmented image 520 (e.g., the original data 502 segmented into objects using bounding boxes), as illustrated by FIG. 5B. In some embodiments, the model is an object classification model that is trained on known object classes such as Imagenet. The object classification model takes cluster representation images as input (e.g., a cluster of images depicting a baseball player). The object classification model classifies an object of interest, and outputs a suggestion of a label based upon a confidence score.

During operation 408 of method 400, a set of entities to mask are identified based upon source data and privacy laws 540 (privacy regulations of the source region) and/or destination data and privacy laws 542 (privacy regulations of the destination region), as illustrated by FIG. 5C. In particular, a contextual prompt 544 is generated for a model, such as a generative large language model 546 based upon the source data and privacy laws 540 and/or destination data and privacy laws 542. In this way, the model processes the contextual prompt 544 to identify a set of key classes 548 corresponding to entities to mask (e.g., a face class corresponding to face entities within the image data 506).

During operation 410 of method 400, the image data 506 (raw image) and the key classes 548 corresponding to the set of entities to mask are processed by a masking engine 554 to generate augmented data 556 such as an augmented image, as illustrated by FIG. 5D. The masking engine 554 masks (e.g., blurs, blacks out, etc.) any objects matching entities within the set of entities. In this way, a subset of the image data 506 is masked to create the augmented data 556 (e.g., an augmented image may have faces blurred out, while bodies are still visible so that the augmented image can be used for security monitoring). During operation 412 of method 400, the augmented data 556 is provided to the computing device within the destination region.

The data masking component 504 may be used to create augmented data 556 for various technical use cases. In some embodiments, the augmented data 556 may be used for image classification functionality to classify an image (e.g., an image of a baseball game), image segmentation functionality, object tracking functionality (e.g., tracking people where merely the faces are blurred), pose estimation functionality, image parsing functionality, process automations functionality, etc.

According to some embodiments, a method is provided. The method includes selecting a first augmentation pipeline to process first data based upon a data type of the first data; performing, by the first augmentation pipeline, entity tagging to assign tags to tokens within the first data to create tagged tokens that are tagged as either being entity tokens or non-entity tokens; generating a first contextual prompt for a model based upon the tagged tokens and privacy regulations of at least one of a source region or a destination region; processing the first contextual prompt using the model to identify one or more tagged tokens to mask; masking the one or more tagged tokens within the first data to create augmented first data; and transmitting the augmented first data to a computing device within the destination region.

According to some embodiments, the method includes tokening, by the first augmentation pipeline, the first data to identify the tokens; performing, by the first augmentation pipeline, part of speech tagging to tag the tokens with part of speech tags to create tagged tokens; and processing raw text of the first data and the tagged tokens to identify the entity tokens and the non-entity tokens.

According to some embodiments, the method includes evaluating source privacy regulations of the source region and destination privacy regulations of the destination region to identify a set of entities to mask; and in response to a tagged token corresponding to an entity within the set of entities to mask, masking the tagged token.

According to some embodiments, the method includes utilizing a large language model as the model for processing the first contextual prompt.

According to some embodiments, the method includes selecting a second augmentation pipeline to process second data based upon a data type of the second data; identifying, by the second augmentation pipeline, objects within the second data; classifying the objects with labels identifying the objects to create labeled objects; and identifying a set of entities to mask based upon the privacy regulations; and processing, by a masking engine, the second data and the set of entities to mask to generate augmented second data to transmit to a destination computing device at the destination region.

According to some embodiments, the second data comprises visual data, and wherein a subset of the visual data is masked to create the augmented second data.

According to some embodiments, the method includes inputting the

augmented second data into at least one of image classification functionality, image segmentation functionality, object tracking functionality, pose estimation functionality, image parsing functionality, or process automations functionality.

According to some embodiments, the method includes inputting the augmented first data into at least one of a chatbot, an intent identification model, a churn propensity model, market analysis functionality, variable regression, or functionality that generates instructions for controlling network equipment of a communication network.

According to some embodiments, the first data comprises text, and wherein a subset of the text is masked to create the augmented first data.

According to some embodiments, a system comprising one or more processors configured for executing the instructions to perform operations, is provided. The operations include selecting a first augmentation pipeline to process first data based upon a data type of the first data; identifying, by the first augmentation pipeline, objects within the first data; classifying the objects with labels identifying the objects to create labeled objects; identifying a set of entities to mask based upon privacy regulations of at least one of a source region or a destination region; processing, by a masking engine, the first data and the set of entities to mask to generate augmented first data; and transmitting the augmented first data to a computing device within the destination region.

According to some embodiments, the operations include inputting the augmented first data into at least one of image classification functionality, image segmentation functionality, object tracking functionality, pose estimation functionality, image parsing functionality, or process automations functionality.

According to some embodiments, the first data comprises visual data, and wherein a subset of the visual data is masked to create the augmented first data.

According to some embodiments, the operations include detecting a gradient shift within the first data; creating a bounding box around an object based upon the gradient shift; and assigning the label to the bounding box.

According to some embodiments, the operations include utilizing a neural network model to segment boundaries within the first data to identify the objects.

According to some embodiments, the operations include generating a contextual prompt for a model based upon the privacy regulations; and processing the contextual prompt using the model to identify the set of entities.

According to some embodiments, the operations include selecting a second augmentation pipeline to process second data based upon a data type of the second data; performing, by the second augmentation pipeline, entity tagging to tag tokens within the second data as tagged tokens tagged as either being entity tokens or non-entity tokens; generating a contextual prompt for a model based upon the tagged tokens and the privacy regulations; processing the contextual prompt using the model to identify one or more tagged tokens to mask; masking the one or more tagged tokens within the second data to create augmented second data; and transmitting the augmented second data to a target computing device within the destination region.

According to some embodiments, the operations include inputting the augmented second data into at least one of a chatbot, an intent identification model, a churn propensity model, market analysis functionality, variable regression, or functionality that generates instructions for controlling network equipment of a communication network.

According to some embodiments, a non-transitory computer-readable medium storing instructions that when executed facilitate performance of operations, is provided. The operations include selecting a augmentation pipeline to process data based upon a data type of the data; performing, by the augmentation pipeline, entity tagging to assign tags to tokens within the first data to create tagged tokens that are tagged as either being entity tokens or non-entity tokens; generating a contextual prompt for a model based upon the tagged tokens and privacy regulations of at least one of a source region or a destination region; processing the contextual prompt using the model to identify one or more tagged tokens to mask; masking the one or more tagged tokens within the data to create augmented data; and transmitting the augmented data to a computing device within the destination region.

According to some embodiments, the operations include inputting the augmented data into at least one of a chatbot, an intent identification model, a churn propensity model, market analysis functionality, variable regression, or functionality that generates instructions for controlling network equipment of a communication network.

According to some embodiments, the operations include evaluating source privacy regulations of the source region and destination privacy regulations of the destination region to identify a set of entities to mask; and in response to a tagged token corresponding to an entity within the set of entities to mask, masking the tagged token.

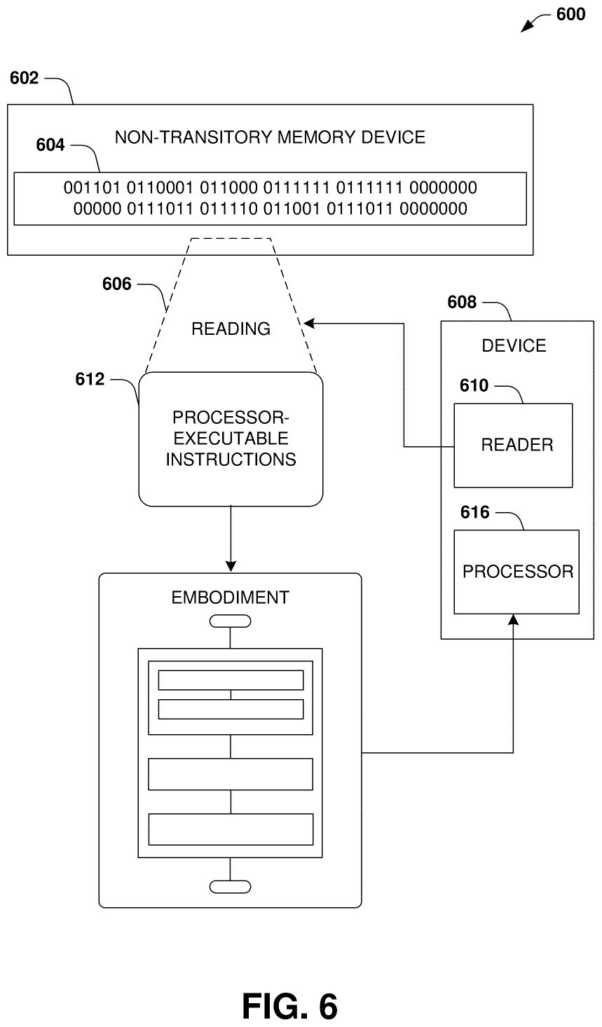

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 100 of FIG. 1, at least some of example system 300 of FIG. 3.

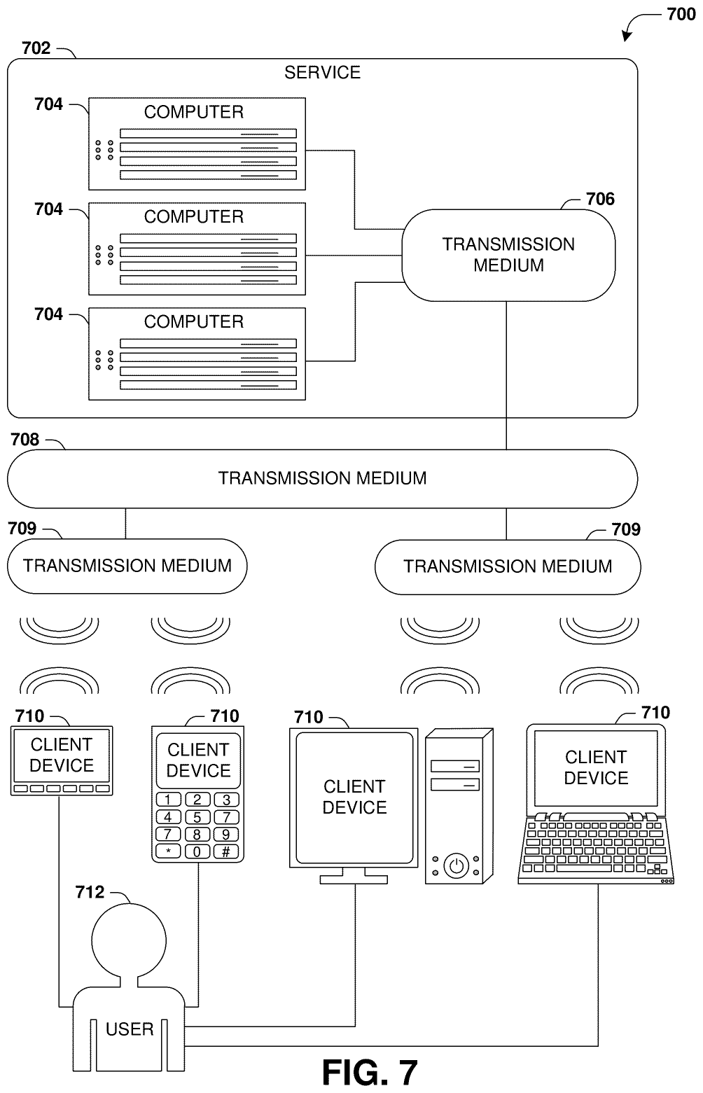

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

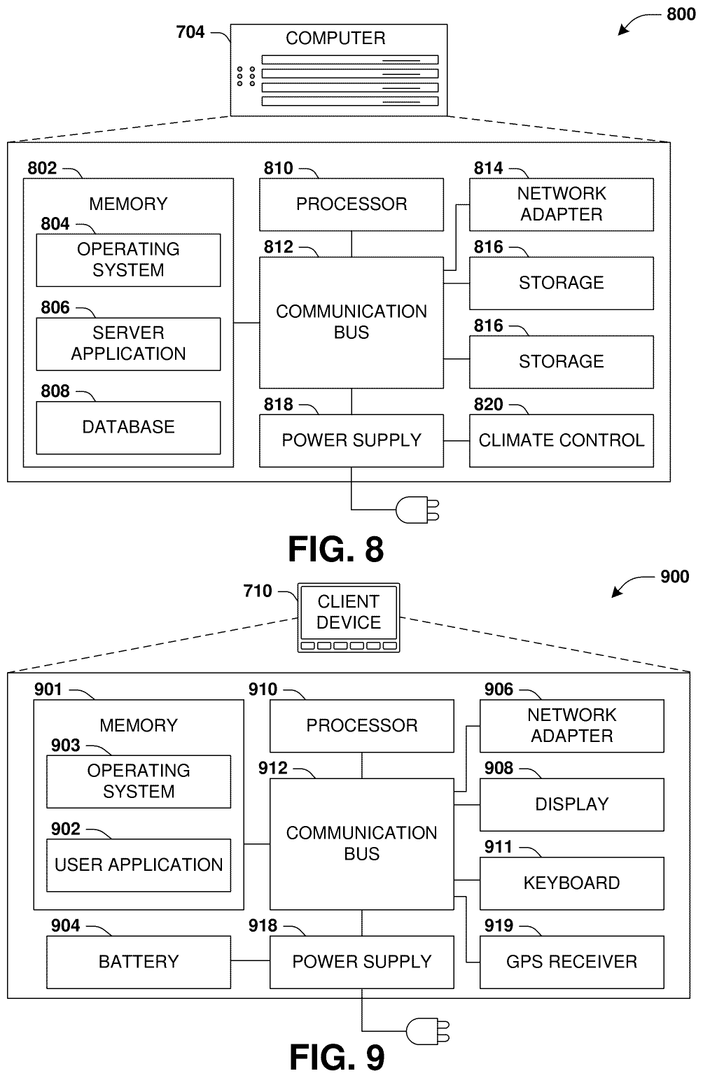

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
selecting a first augmentation pipeline to process first data based upon a data type of the first data;
performing, by the first augmentation pipeline, entity tagging to assign tags to tokens within the first data to create tagged tokens that are tagged as either being entity tokens or non-entity tokens;
generating a first contextual prompt for a model based upon the tagged tokens and privacy regulations of at least one of a source region or a destination region;
processing the first contextual prompt using the model to identify one or more tagged tokens to mask;
masking the one or more tagged tokens within the first data to create augmented first data; and
transmitting the augmented first data to a computing device within the destination region.

2. The method of claim 1, comprising:
tokening, by the first augmentation pipeline, the first data to identify the tokens;
performing, by the first augmentation pipeline, part of speech tagging to tag the tokens with part of speech tags to create tagged tokens; and
processing raw text of the first data and the tagged tokens to identify the entity tokens and the non-entity tokens.

3. The method of claim 1, comprising:
evaluating source privacy regulations of the source region and destination privacy regulations of the destination region to identify a set of entities to mask; and
in response to a tagged token corresponding to an entity within the set of entities to mask, masking the tagged token.

4. The method of claim 1, comprising:
utilizing a large language model as the model for processing the first contextual prompt.

5. The method of claim 1, comprising:
selecting a second augmentation pipeline to process second data based upon a data type of the second data;
identifying, by the second augmentation pipeline, objects within the second data;
classifying the objects with labels identifying the objects to create labeled objects; and
identifying a set of entities to mask based upon the privacy regulations; and
processing, by a masking engine, the second data and the set of entities to mask to generate augmented second data to transmit to a destination computing device at the destination region.

6. The method of claim 5, wherein the second data comprises visual data, and wherein a subset of the visual data is masked to create the augmented second data.

7. The method of claim 5, comprising:
inputting the augmented second data into at least one of image classification functionality, image segmentation functionality, object tracking functionality, pose estimation functionality, image parsing functionality, or process automations functionality.

8. The method of claim 1, comprising:
inputting the augmented first data into at least one of a chatbot, an functionality, variable regression, or functionality that generates instructions for controlling network equipment of a communication network.

9. The method of claim 1, wherein the first data comprises text, and wherein a subset of the text is masked to create the augmented first data.

10. A system, comprising:
one or more processors configured for executing instructions to perform operations comprising:
selecting a first augmentation pipeline to process first data based upon a data type of the first data;
identifying, by the first augmentation pipeline, objects within the first data;
classifying the objects with labels identifying the objects to create labeled objects;
identifying a set of entities to mask based upon privacy regulations of at least one of a source region or a destination region;
processing, by a masking engine, the first data and the set of entities to mask to generate augmented first data; and
transmitting the augmented first data to a computing device within the destination region.

11. The system of claim 10, wherein the operations further comprise:
inputting the augmented first data into at least one of image classification functionality, image segmentation functionality, object tracking functionality, pose estimation functionality, image parsing functionality, or process automations functionality.

12. The system of claim 10, wherein the first data comprises visual data, and wherein a subset of the visual data is masked to create the augmented first data.

13. The system of claim 10, wherein the operations further comprise:
detecting a gradient shift within the first data;
creating a bounding box around an object based upon the gradient shift; and
assigning the label to the bounding box.

14. The system of claim 10, wherein the operations further comprise:
utilizing a neural network model to segment boundaries within the first data to identify the objects.

15. The system of claim 10, wherein the operations further comprise:
generating a contextual prompt for a model based upon the privacy regulations; and
processing the contextual prompt using the model to identify the set of entities.

16. The system of claim 10, wherein the operations further comprise:
selecting a second augmentation pipeline to process second data based upon a data type of the second data;
performing, by the second augmentation pipeline, entity tagging to assign tags to tokens within the first data to create tagged tokens that are tagged as either being entity tokens or non-entity tokens;
generating a contextual prompt for a model based upon the tagged tokens and the privacy regulations;
processing the contextual prompt using the model to identify one or more tagged tokens to mask;
masking the one or more tagged tokens within the second data to create augmented second data; and
transmitting the augmented second data to a target computing device within the destination region.

17. The system of claim 16, wherein the operations further comprise:
inputting the augmented second data into at least one of a chatbot, an functionality, variable regression, or functionality that generates instructions for controlling network equipment of a communication network.

18. A non-transitory computer-readable medium storing instructions that when executed facilitate performance of operations comprising:
selecting a augmentation pipeline to process data based upon a data type of the data;
performing, by the augmentation pipeline, entity tagging to tag tokens within the data as tagged tokens tagged as either being entity tokens or non-entity tokens;
generating a contextual prompt for a model based upon the tagged tokens and privacy regulations of at least one of a source region or a destination region;
processing the contextual prompt using the model to identify one or more tagged tokens to mask;
masking the one or more tagged tokens within the data to create augmented data; and
transmitting the augmented data to a computing device within the destination region.

19. The non-transitory computer-readable medium of claim 18, wherein the operations further comprise:
inputting the augmented data into at least one of a chatbot, an intent identification model, a churn propensity model, market analysis functionality, variable regression, or functionality that generates instructions for controlling network equipment of a communication network.

20. The non-transitory computer-readable medium of claim 18, wherein the operations further comprise:
evaluating source privacy regulations of the source region and destination privacy regulations of the destination region to identify a set of entities to mask; and
in response to a tagged token corresponding to an entity within the set of entities to mask, masking the tagged token.
